(19) United States
(12) Patent Application Publication
(10) Pub. No.: US 2018/0198704 A1
(43) Pub. Date: Jul. 12, 2018

(54) PRE-PROCESSING OF DATA PACKETS WITH NETWORK SWITCH APPLICATION -SPECIFIC INTEGRATED CIRCUIT

(71) Applicant: Hewlett Packard Enterprise Development LP, Houston, TX (US)

(72) Inventors: Claudio Enrique Viquez, Heredia (CR); Jose Daniel Hernandez, Heredia (CR); Osvaldo Andres Sanchez, Heredia (CR); Diego Valverde, Heredia (CR)

(21) Appl. No.: 15/759,367

(22) PCT Filed: Sep. 25, 2015
(86) PCT No.: PCT/US2015/052226

§ 371 Date: Mar. 12, 2018

(51) Int. Cl. H04L 12/725; H04L 29/06; H04L 12/741; H04L 12/721

(52) U.S. Cl. CPC H04L 45/306; H04L 69/22; H04L 2212/00; H04L 45/66; H04L 69/04; H04L 45/745

(57) ABSTRACT

In some examples, a method includes receiving, with a programmable Application-Specific Integrated Circuit (ASIC) of a network switch, data packet pre-processing instructions; receiving, with the ASIC, a data packet including payload data and metadata; extracting, with the ASIC, a subset of the metadata based on the received pre-processing instructions; compiling, with the ASIC, the extracted subset of metadata into a data structure; and sending, to the CPU, the data structure compiled by the ASIC.

### BACKGROUND

Computer networks can be used to allow networked devices, such as personal computers, servers, and data storage devices to exchange data. Computer networks often include intermediary datapath devices such as network switches, gateways, and routers, to flow traffic along selected datapaths for routing data between networked devices.

### BRIEF DESCRIPTION OF DRAWINGS

FIG. 1 is a diagram of a network, according to an example.

FIG. 2 is a flowchart for a method, according to an example.

FIG. 3 is a flowchart for a method, according to another example.

FIG. 4 is a flowchart for a method, according to another example.

FIG. 5 is a flowchart for a method, according to another example.

FIG. 6 is a diagram of network switch, according to an example.

FIG. 7 is a diagram of network switch, according to another example.

FIG. 8 is a diagram of machine-readable storage medium, according to an example.

### DETAILED DESCRIPTION

The following discussion is directed to various examples of the disclosure. Although one or more of these examples may be preferred, the examples disclosed herein should not be interpreted, or otherwise used, as limiting the scope of the disclosure, including the claims. In addition, the following description has broad application, and the discussion of any example is meant only to be descriptive of that example, and not intended to intimate that the scope of the disclosure, including the claims, is limited to that example. Throughout the present disclosure, the terms “a” and “an” are intended to denote at least one of a particular element. In addition, as used herein, the term “includes” means includes but not limited to, the term “including” means including but not limited to. The term “based on” means based at least in part on.

Certain implementations of the present disclosure are directed to pre-processing of data packets with an Application-Specific Integrated Circuit (ASIC) of a network switch. For example, an implementation in the form of a method performed by a network switch can include: (a) receiving, with the ASIC, data packet pre-processing instructions; (b) receiving, with the ASIC, a data packet including payload data and metadata; (c) extracting, with the ASIC, a subset of the metadata based on the received pre-processing instructions; (e) compiling, with the ASIC, the extracted subset of metadata into a data structure; and (f) sending, to the CPU, the data structure compiled by the ASIC.

Such pre-processing can, in some implementations and situations, allow for reduced load on a network switch's CPU by extracting inside the ASIC relevant information for particular switching and/or routing operations. Moreover, in some implementations and situations, embedded programmable packet processors within an ASIC can have access to certain registers, configuration information, and state information that may not be visible to the network switch's CPU. The ASIC can then send this information to the CPU for analysis by the CPU. In some implementations and situations, embedded packet processors can give more visibility to applications running in the CPU for debugging purposes. Moreover, in some situations, a payload of the packet may not be relevant to a specific operation of the network switch. In view of this, pre-processing the data packet with an ASIC can include sending the CPU only information relevant to the specific operation of the CPU, thereby reducing the amount of memory that is consumed in the CPU to store network packets and further reduce an amount of CPU load to process network packets. The implementations presented herein can include additional and/or alternative advantages, many of which will be apparent upon review of the description and figures.

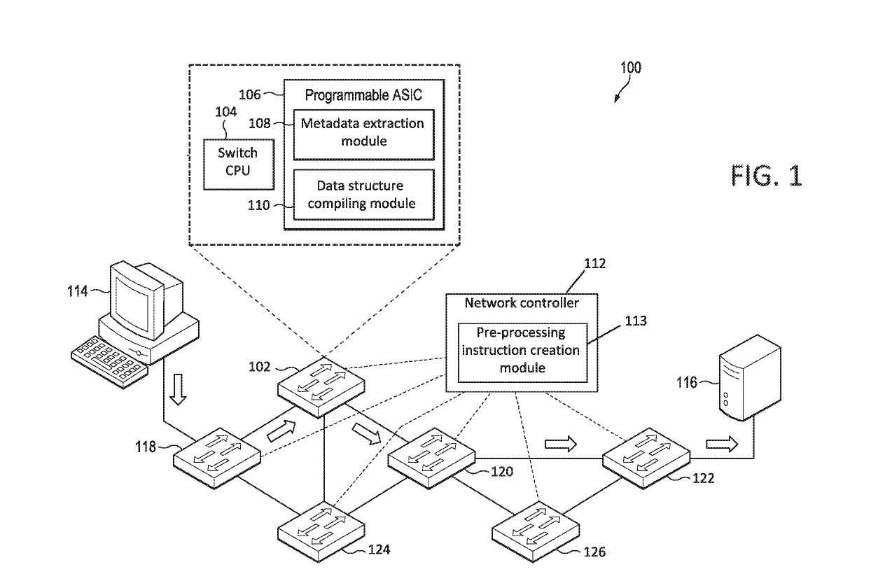

FIG. 1 is a diagram of an example network 100 including an example network switch 102 housing a switch CPU 104 and a programmable ASIC 106 having various combined hardware and software modules (such as metadata extraction module 108 and data structure compiling module 110, which are described in further detail below). Network 100 can, in some implementations, include a network controller 112 that can send and receive traffic control or other operation instructions or information to one or more nodes in network 100, as described in further detail below. As described in further detail below, network controller 112 can include one or more combined hardware and software modules (such as pre-processing instruction creation module 113, which is described in further detail below). FIG. 1 depicts network traffic along a datapath between an example source node 114 and example destination node 116, the datapath being defined by network nodes 118, 102, 120 and 122. Other network nodes, such as nodes 124 and 126 are included within network 100 but are not used in this datapath. It is appreciated that the datapath can be determined by network controller 112 (or another entity, such as by a network administrator, by datapath nodes themselves, etc.) based on one or more static parameters (e.g., link speeds, number of hops between nodes, etc.) and car further (or alternatively) be based on one or more dynamic parameters (e.g., QoS, network latency, network throughput, network power consumption, etc.).

It is appreciated that the term “ASIC” as used herein can, for example, include related technologies such as application-specific field-programmable gate arrays (FPGAs), which can, for example contain an array of programmable logic blocks, and a hierarchy of reconfigurable interconnects that allow the blocks to be wired together. Suitable ASICs for use with the present disclosure can, for example, allow for logic blocks to be configured to perform complex combinational functions as well as simple logic gates like AND and XOR. Suitable ASICs for use with the present disclosure can, for example, also include memory elements, which may be simple flip-flops or more complete blocks of memory.

Network nodes within network 100 can forward traffic along a datapath based on metadata within the traffic. As but a few examples, metadata can be in the form of Media Access Control (MAC) addresses, Internet Protocol (IP) addresses, port numbers, etc. Traffic in the form of a packet can be received at network switch 102 (or another suitable intermediary network node). Source node 114 and destination node 116 can, for example, be in the form of network hosts or other types of network nodes. For example, one or both of source node 114 and destination node 116 can be in the form of suitable servers, desktop computers, laptops, printers, etc. As but one example, source node 114 can be in the form of a desktop computer including a monitor for presenting information to an operator and a keyboard and mouse for receiving input from an operator, and destination node 116 can be in the form of a standalone storage server appliance. It is appreciated that source node 114 and destination node 116 can be endpoint nodes on network 100, intermediate nodes between endpoint nodes, or positioned at other logical or physical locations within network 100.

The various intermediary nodes within network 100 can, for example, be in the form of switches or other multi-port network bridges that process and forward data at the data link layer. In some implementations, one or more of the nodes can be in the form of multilayer switches that operate at multiple layers of the Open Systems Connection (OSI) model (e.g., the data link and network layers). Although the term “network switch” is used throughout this description, it is appreciated that this term can refer broadly to other suitable network data forwarding devices. For example, a general purpose computer can include suitable hardware and machine-readable instructions that allow the computer to function as a network switch. It is appreciated that the term “switch” can include other network datapath elements in the form of suitable routers, gateways and other devices that provide switch-like functionality for network 100.

In some implementations, a given network switch in a network (e.g., switch 102) can rely on flow rules stored on the switch (or otherwise accessible by the switch) for forwarding or otherwise handling traffic. Flow rules can, for example, contain information such as: (1) match fields to match against packets (e.g., an ingress port and specific packet header fields), (2) a priority value for the flow rule to allow prioritization over other flow entries, (3) counters that are updated when packets are matched, (4) instructions to modify the action set or pipeline processing, (5) timeouts indicating a maximum amount of time or idle time before a flow is expired by the switch, and (6) a cookie value which can be used by a network controller or other entity to filter flow statistics, flow modification, and flow deletion. As described in further detail below, such flow rules can be transmitted to the switch via a network controller, directly by an administrator or other entity via a command line interface (CLI) or graphical user interface (GUI), or through another suitable input.

The various nodes within network 100 are connected via one or more data channels, which can, for example be in the form of data cables or wireless data channels. Although a single link (i.e., a single line in FIG. 1) between each network node is illustrated, it is appreciated that each single link may include multiple wires or other wired or wireless data channels. Moreover, FIG. 1 further depicts network controller 112 as being connected to each network nodes via broken lines, which is intended to illustrate logical control channels between network controller 112 and respective nodes. However, it is appreciated that network controller 112 may be directly connected to only one or a few network nodes, while being indirectly connected to other nodes of network 100. As but one example, network controller 112 can be directly connected to node 120 via an Ethernet cable, while being indirectly connected to node 122 (e.g., by relying on node 120 as an intermediary for communication with node 122). In such a situation, the control channel can be considered a direct logical channel between network controller 112 and node 122 and is formed by a first physical channel (e.g., a first Ethernet cable) that connects network controller 112 to node 120 and by a second physical channel (e.g., a second Ethernet cable) that connects node 120 to node 122.

Network 100 can, for example, be implemented as a Software-Defined Network (SDN). Software-defined networking can allow for the decoupling of traffic routing control decisions (e.g., which port of a network switch should be used to forward traffic en route to a given destination) from the network's physical infrastructure. For example, in a Software-Defined Network (SDN), such traffic routing control decisions can be determined by an entity (e.g., a network controller) that is different from the routing device itself (e.g., the network switch tasked with forwarding the traffic). A network controller used in implementing an SDN (i.e., a network controller) can, for example, be programmed to: (1) receive dynamic parameters of the network from intermediary datapath devices (e.g., network switches), (2) decide how to route packets over the network, and (3) inform the devices about these decisions. Network controllers can, for example, be configured to access and control multiple devices within the SDN via a network communication channel. Such a network communication channel can be referred to as a “control channel,” an “OpenFlow channel” (for SDN's implemented using the OpenFlow protocol), a “communication channel,” an “interface channel,” etc. In some networks, a network controller can use such a control channel to configure devices (e.g., configure flows stored on devices), receive data packets, send packets using the device, gather state and statistics from devices, and/or other uses.

In some networks, SDN applications are run on the network controller or on other devices on the network (or otherwise in communication with the network) and interfaced with the network controller to meet customer use cases, such as to achieve a desired throughput (or another Quality of Service (QoS)) over the SDN, enforce security provisions for the SDN, or provide another suitable service or functionality.

The functionality of network controller 112 can, for example, be implemented in part via a software program on a standalone machine, such as a standalone server. In some implementations, network controller 112 can be implemented on multi-purpose machines, such as a suitable desktop computer, laptop, tablet, or the like. In some implementations, network controller 112 can be implemented on a suitable non-host network node, such as certain types of network switches. It is appreciated that the functionality of network controller 112 may be split among multiple controllers or other devices. For example, network 100 is described and illustrated as including only one network controller 112. However, it is appreciated that the disclosure herein can be implemented in SDNs with multiple controllers. For example, in some SDNs, network devices are in communication with multiple controllers such that control of the network can be smoothly handed over from a first controller to a second controller if a first controller fails or is otherwise out of operation. As another example, multiple controllers can work together to concurrently control certain SDNs. In such SDNs, a first controller can, for example, control certain network devices while a second controller can control other network devices. In view of the above, reference in this application to a single network controller 112 that controls the operation of network 100 is intended to include such multiple controller configurations (and other suitable multiple controller configurations).

Within the context of an SDN, controlled network nodes (e.g., switch 102) can be used as sensors in the network as they have information about dynamic network parameters. When polled via standard SDN interfaces the devices can report this information to network controller 112. Network 100 can, for example, be implemented through the use of network controller 112 that interfaces with various SDN-compatible devices via a suitable Application Program Interface (“API”) or a suitable SDN protocol (e.g., OpenFlow) or other protocol.

As used herein, the term “controlled” and similar terminology in the context of SDN-compatible network nodes, such as “controlled switches,” is intended to include devices within the control domain of network controller 112 or otherwise controllable by network controller 112. Such a controlled node can, for example, communicate with network controller 112 and network controller 112 is able to manage the node in accordance with an SDN protocol, such as the Open Flow protocol. For example, an OpenFlow-compatible switch controlled by network controller 112 can permit network controller 112 to add, update, and delete flow entries in flow tables of the switch using suitable SDN commands.

In the example network 100 depicted in FIG. 1, the various network nodes are in the form of intermediary nodes (e.g., controlled network switch 102) and host devices (source node 114 and destination node 116). It is appreciated however, that the implementations described herein can be used or adapted for networks including more or fewer devices, different types of devices, and different network arrangements. It is further appreciated that the disclosure herein can apply to suitable SDNs (e.g., certain hybrid or heterogeneous SDNs) in which some devices are controlled by a network controller (e.g., network controller 112) and some devices are not controlled by the network controller (e.g., network controller 112 or any other network controller). For example, in some implementations, at least one node (e.g., node 120) along a given datapath is controlled by network controller 112 and at least one node along the given datapath (node 124) is not controlled by network controller 112.

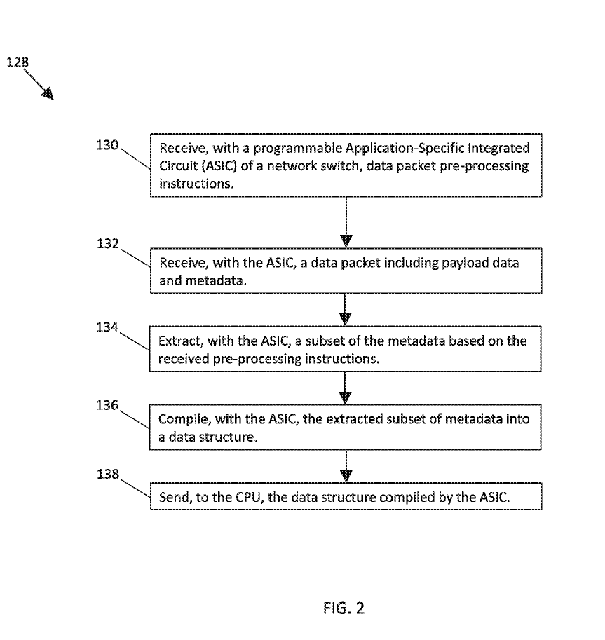

FIG. 2 illustrates a flowchart for a method 128 according to an example of the present disclosure. For illustration, the description of method 128 and its component steps make reference to example network 100 and elements thereof, such as for example network switch 102, etc., however, it is appreciated that method 128 or aspects thereof can be used or otherwise applicable for any suitable network or network element described herein or otherwise. For example, method 128 can be applied to computer networks with different network topologies than those illustrated in FIG. 1.

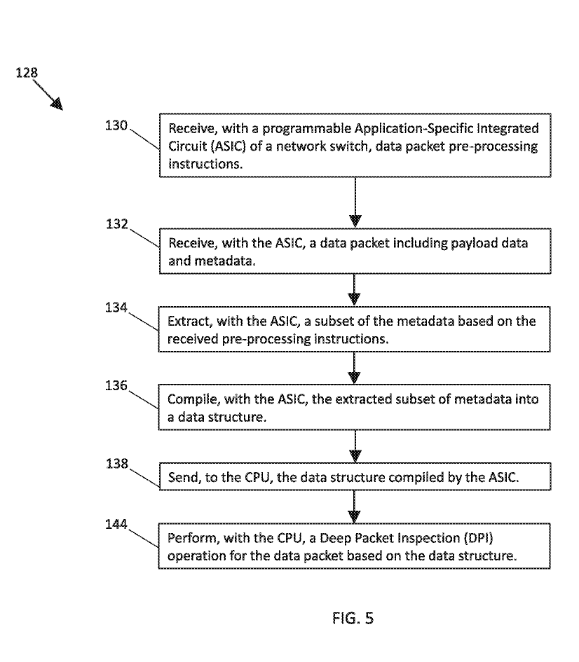

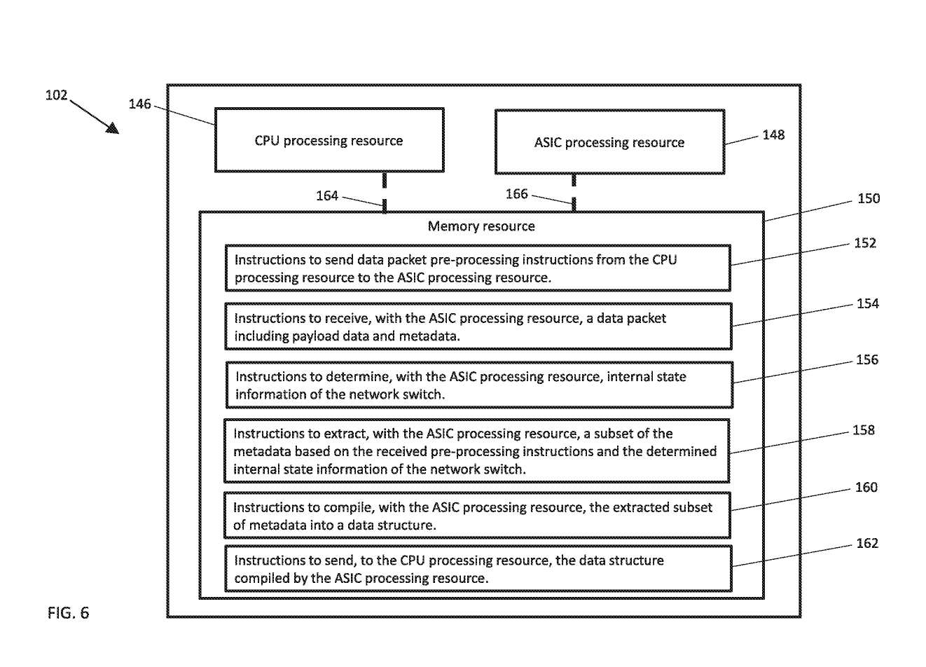

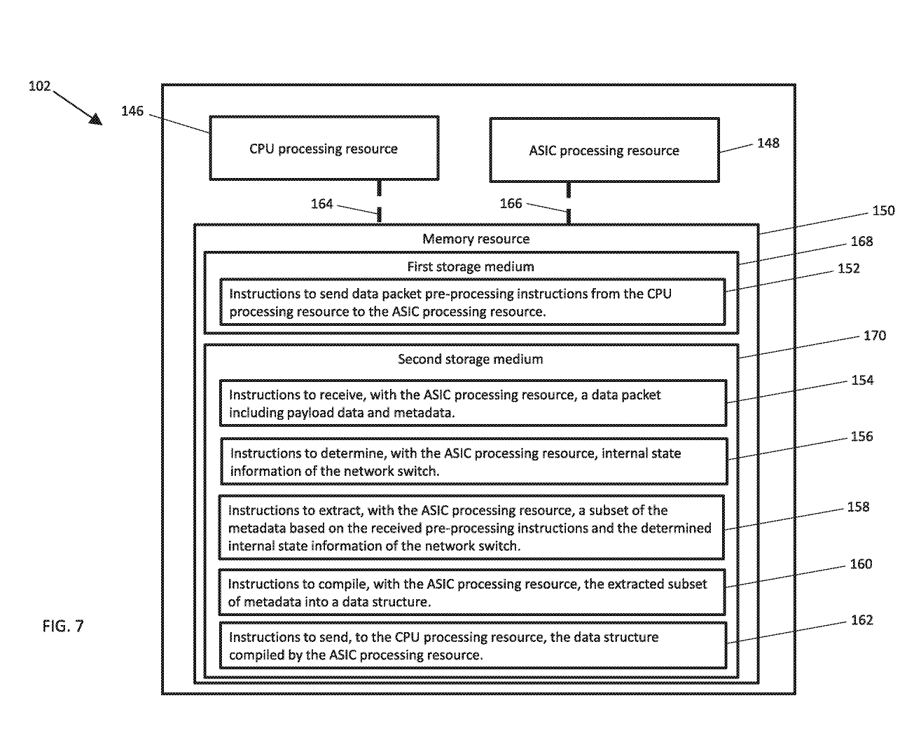

In some implementations, method 128 can be implemented or otherwise executed through the use of executable instructions stored on a memory resource (e.g., the memory resource of the network switch of FIGS. 5 and 6), executable machine readable instructions stored on a storage medium (e.g., the medium of FIG. 7), in the form of electronic circuitry (e.g., on an ASIC), and/or another suitable form. Although the description of method 128 herein primarily refers to steps performed on network switch 102 for purposes of illustration, it is appreciated that in some implementations, method 128 can be executed on another computing device within network 100 and/or in data communication with network switch 102.

Method 128 includes receiving (at block 130), with ASIC 106, data packet pre-processing instructions. The instructions can, for example, be communicated from CPU 104 to ASIC 106 via a suitable communication link of network switch 102. For example, the communication link can be in the form of a suitable electronic bus internal to network switch 102. The pre-processing instructions can, for example be generated by CPU 104 itself, another processor resource of network switch 102, or a processing resource external to network switch 102. For example, in some implementations, the pre-processing instructions can be automatically generated by network controller 112 (e.g., automatically generated based on dynamic and/or static network parameters reported to network controller 112), manually generated (e.g., determined by a network administrator), selected by network controller 112 or a network administrator from a list of acceptable instructions, etc.

As described in further detail below, the pre-processing instructions can identify specific fields or other data of interest from a data packet for use in an operation performed by CPU. For example, the data packet pre-processing instructions may instruct ASIC 106 to compile a data structure including only data that is used for a specific CPU control task. That is, for some operations, such as a L2 learning/move operation or Deep Packet Inspection (DPI) operation, the CPU may be interested in the data packet's Virtual Local Area Network (VLAN), the data packet's source and destination MAC address information for the data packet, as well as the port of network switch 102 that received the data packet. It is appreciated that the above is just an example of certain fields that may be of interest to a specific operation and that other field or information may be of interest for the same operations or different operations. For example, in some implementations, payload data of the packet may be of interest to the CPU (e.g., for certain DPI operations). In such an implementation, the pre-processing instructions can identify the payload as being of interest to the CPU. In some implementations, an SDN protocol can be used to provide control instructions to switch 102 and/or programmable ASIC 106. For example, network controller 112 can, in some implementations, be in the form of an SDN controller and can prepare and/or send the data packet pre-processing instructions to ASIC 106 of switch 102. In such an implementation, the data packet pre-processing instructions can, for example, be in accordance with an objective of an SDN application running on the SDN controller.

Method 128 includes receiving (at block 132), with ASIC 106, a data packet including payload data and metadata. The data packet can, for example be received through a port of network switch 102. For consistency, the industry term “packet” is used throughout this description, however, it is appreciated that the term “packet” as used herein can refer to any suitable protocol data unit (PDU). Such a packet can, for example, include payload data as well as metadata in the form of control data. Control data can, for example, provide data to assist network switch 102 with reliably delivering payload data. For example, control data can include network addresses for source node 114 and destination node 116, error detection codes, sequencing information, packet size of the packet, a time-to-live (TTL) value, etc. In contrast, payload data can include data carried on behalf of an application for use by source node 114 and destination node 116.

Method 128 includes extracting (at block 134), with ASIC 106, a subset of the metadata based on the received pre-processing instructions. As provided above, the pre-processing instructions can identify specific fields or other data of interest from a data packet for use in an operation performed by CPU. For example, and as described above, the CPU may be interested in the data packet's Virtual Local Area Network (VLAN), the data packet's source and destination MAC address information for the data packet, as well as the port of network switch 102 that received the data packet. In block 134, this metadata is extracted from the data packet for further processing by ASIC 106.

Method 128 includes compiling (at block 136), with ASIC 106, the extracted subset of metadata into a data structure. In some implementations, only metadata is included in the compiled data structure. That is, the data structure does not store the payload data of the data packet. In other implementations, both metadata and payload data is stored in the data structure. A data structure for use with the present disclosure can include any suitable structure that organizing data for use by a computer. An example data structure can include fixed-length or resizable arrays, which can for example list a number of elements in a specific order that are accessible using an integer index to specify which element is requested. In some implementations, associative arrays, such as hash tables, may also be used as suitable data structures. In some implementations, aggregated data structures, such as records that contain other elements in the forms of fields or members, can be used. It is appreciated that any suitable data structure may be used. As another example, a data packet itself may be considered a data structure. For example, in some implementations, a compressed data packet that eliminates certain irrelevant metadata fields and/or payload data from the original data packet can be compiled by ASIC 106.

Based on the example provided above for block 136, in some implementations, the data structure can store VLAN information, MAC address and a destination MAC address for the data packet, and port information for a port of the network switch that received the data packet.

Method 128 includes sending (at block 138), to CPU 104, the data structure compiled by ASIC 106. The compiled data structure can, for example, be communicated from ASIC 106 to CPU 104 via a suitable communication link of network switch 102. For example, the communication link can be in the form of a suitable electronic bus internal to network switch 102. In some implementations, only the compiled data structure (and not, for example, the original data packet) is sent to CPU 104 from ASIC 106. In some implementations, an SDN protocol can be used to send the data structure to one or more nodes of network 100 to a network controller 112 or other entity. For example, network controller 112 can, in some implementations, be in the form of an SDN controller and can receive the data structure for further processing and/or analysis. In such an implementation, the data structure can, for example, be used in accordance with an objective of an SDN application running on the SDN controller.

Although the flowchart of FIG. 2 shows a specific order of performance, it is appreciated that this order may be rearranged into another suitable order, may be executed concurrently or with partial concurrence, or a combination thereof. Likewise, suitable additional and/or comparable steps may be added to method 128 or other methods described herein in order to achieve the same or comparable functionality. In some implementations, one or more steps are omitted. For example, in some implementations, block 138 of sending the data structure to the CPU can be omitted from method 128 (e.g., if the data packet does not include any relevant metadata). It is appreciated that blocks corresponding to additional or alternative functionality of other implementations described herein can be incorporated in method 128. For example, blocks corresponding to the functionality of various aspects of switch 102 otherwise described herein can be incorporated in method 128 even if such functionality is not explicitly characterized herein as a block in a method.

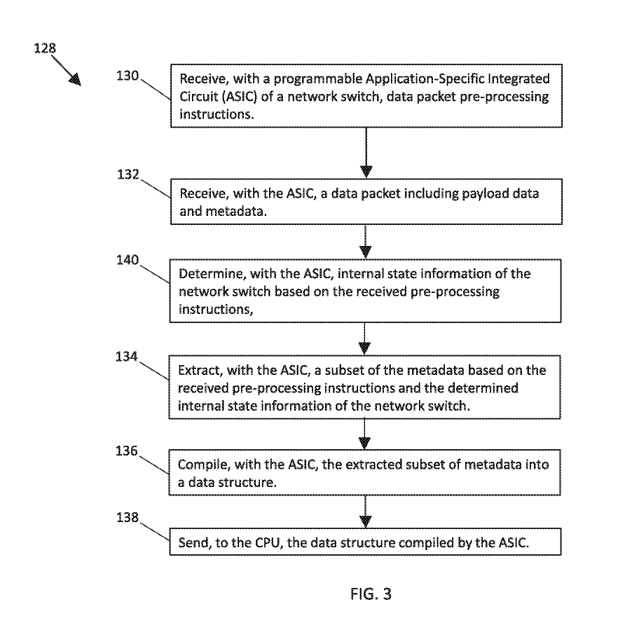

FIG. 3 illustrates another example of method 128 in accordance with the present disclosure. For illustration, FIG. 3 reproduces various blocks from method 128 of FIG. 2, however it is appreciated that method 128 of FIG. 3 can include additional, alternative, or fewer steps, functionality, etc., than method 128 of FIG. 2 and is not intended to be limited by the diagram of FIG. 1 (or vice versa) or the related disclosure thereof. It is further appreciated that method 128 of FIG. 2 can incorporate one or more aspects of method 128 of FIG. 3 and vice versa. For example, in some implementations, method 128 of FIG. 2 can include the additional step described below with respect to method 128 of FIG. 3.

Method 128 includes determining (at block 140), with ASIC 106, internal state information of network switch 102 based on the received pre-processing instructions. The state information can correspond to different switching scenarios for network switch 102. In some implementations, block 140 includes determining, with ASIC 106, state information that is not visible to CPU 104. Internal state information can, for example, include internal states and variables of the switch, such as VLAN, Quality of Service (QoS) parameters and the packet time stamp as well as internal switch states, such as L2 table information, L3 table information, ACL's, debug information, statistics, counter, meters, etc. In this implementation, block 140 of extracting a subset of metadata includes extracting a subset of metadata based on both the received pre-processing instructions and the determined internal state information of the network switch.

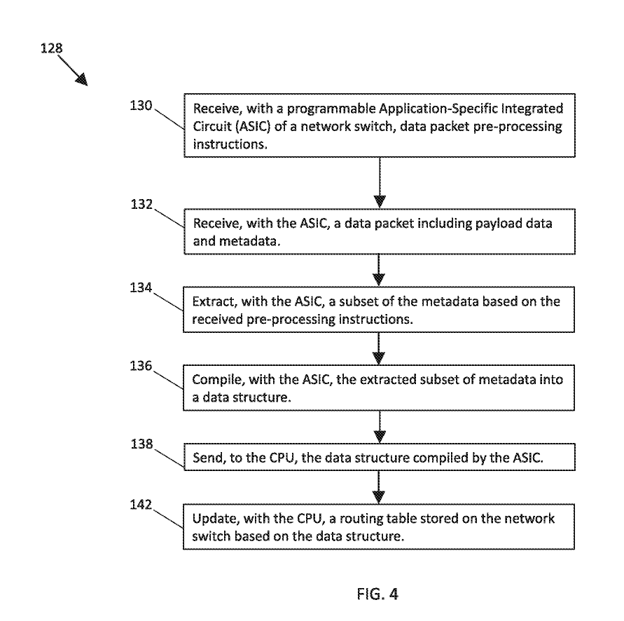

FIG. 4 illustrates another example of method 128 in accordance with the present disclosure. For illustration, FIG. 4 reproduces various blocks from method 128 of FIG. 2, however it is appreciated that method 128 of FIG. 4 can include additional, alternative, or fewer steps, functionality, etc., than method 128 of FIG. 2 and is not intended to be limited by the diagram of FIG. 1 (or vice versa) or the related disclosure thereof. It is further appreciated that method 128 of FIG. 2 can incorporate one or more aspects of method 128 of FIG. 4 and vice versa. For example, in some implementations, method 128 of FIG. 2 can include the additional step described below with respect to method 128 of FIG. 4.

Method 128 can include performing one or more actions with CPU 104 based on the received compiled data structure. In some implementations, actions can be applied for a predefined amount of time (e.g., by associating timers to the action) or a predefined number of bytes (e.g., by associating bytes counters to the action), and/or other conditions. In some implementations, actions can be performed on the packet level (e.g., forward the packet to a given egress port of switch 102 or modify a packet header) or at another level of network management or routing. For example, Method 128 of FIG. 3 includes updating (at block 142), with CPU 104, a routing table stored on network switch 102 based on the data structure. It is appreciated that other actions may be performed by CPU 104 based on the received compiled data structure, such as the action described below with respect to FIG. 5.

FIG. 5 illustrates another example of method 128 in accordance with the present disclosure. For illustration, FIG. 5 reproduces various blocks from method 128 of FIG. 2, however it is appreciated that method 128 of FIG. 5 can include additional, alternative, or fewer steps, functionality, etc., than method 128 of FIG. 2 and is not intended to be limited by the diagram of FIG. 1 (or vice versa) or the related disclosure thereof. It is further appreciated that method 128 of FIG. 2 can incorporate one or more aspects of method 128 of FIG. 5 and vice versa. For example, in some implementations, method 128 of FIG. 2 can include the additional step described below with respect to method 128 of FIG. 5.

As provided above, method 128 can include performing one or more actions with CPU 104 based on the received compiled data structure. Method 128 of FIG. 5 includes performing (at block 144), with CPU 104, a Deep Packet Inspection (DPI) operation for the data packet based on the data structure. For example, ASIC 106 can be configured to analyze the data packet to search for a suspicious DPI signature. In such an implementation, ASIC 106 can then send any suspicious signatures and/or the data packet itself to CPU 104 (or another entity in network 100 or elsewhere) for further analysis and/or processing.

A specific example implementation will now be described. It is appreciated that this implementation may include certain aspects of other implementations described herein (and vice-versa), but it is not intended to be limiting towards other implementations described herein. In this specific example implementation, embedded programmable packet processors in a switch ASIC are used to grab relevant packet information and construct a data structure with such information and other state information from the switch that is sent to the CPU for different switching scenarios. This can, for example, reduce the amount of memory the CPU uses to process the traffic and can further reduce the overhead of the CPU to parse and process the packet.

In this specific example implementation, with reference to an L2 learning operation, the embedded programmable packet processors in the ASIC can extract the VLAN information, the MAC addresses of the packet and the ingress port of the packet and send this information in a data structure to the local CPU instead of sending the complete packet plus metadata from the switch to the local CPU. An advantage of doing this is that the local CPU of the switch is running several tasks to control and manage all the protocols that the switch is running. If packets are pre-processed inside the ASIC prior to sending them to the applications running in the CPU, more CPU cycles can be used for other important tasks. Also, in some existing switches, the local CPU and the ASIC rely on a zero-copy technique by using a DMA engine when packets are copied from the ASIC to the CPU, however, the amount of time it takes the DMA engine to complete the zero-copy operation is a function of the packet size. That is, bigger packets take more time to be copied from the ASIC to the CPU. In many applications/protocols the payload of the packet may not be of interest to the CPU, thus it could be removed from the packet by using programmable engines inside the ASIC. Also, in some implementations, the programmable engines could remove redundant information from the packet or compress the packet prior to sending them to the CPU, reducing the packet size but keeping the ability to reconstruct the packet if it is to be re-injected to the ASIC.

In one specific example implementation, switch ASIC programmable processors are used to build special control metadata packets that are sent to the CPU for configuration and control purposes. The metadata packets contain only relevant information for a given CPU control task, as opposed to sending the entire packet as it is the case in operations such as L2 learning. Furthermore, in some implementations, the selection of the packet fields is programmable, can be done during run time, and can incorporate internal switch variables such as counters, meters, etc. In some implementations, the CPU has the ability to configure packet fields metadata build process for a specific control operation and can also change according to the switch state or a particular network scenario as prioritized by the CPU.

FIG. 6 is a diagram of an example network switch 102 in accordance with the present disclosure. As described in further detail below, switch 102 includes a CPU processing resource 146, an ASIC processing resource 148, and a memory resource 150 that stores machine-readable instructions 152, 154, 156, 158, 160, and 162. For illustration, the description of switch 102 of FIG. 6 makes reference to various aspects of the diagram of FIG. 1 as well as method 128 of FIGS. 2-5. Indeed, for consistency, the same reference number for the switch of FIG. 1 is used for the switch of FIG. 6. However it is appreciated that switch 102 of FIG. 6 can include additional, alternative, or fewer aspects, functionality, etc., than the implementation described with respect to method 128 as well as the switch of FIG. 1 and is not intended to be limited by the related disclosure thereof.

Instructions 152 stored on memory resource 150 are, when executed by CPU processing resource 146, to send data packet pre-processing instructions from CPU processing resource 146 to ASIC processing resource 148. Instructions 152 can incorporate one or more aspects of blocks of method 128 or another suitable aspect of other implementations described herein (and vice versa).

Instructions 154 stored on memory resource 150 are, when executed by ASIC processing resource 148, to receive, with ASIC processing resource 148, a data packet including payload data and metadata. Instructions 154 can incorporate one or more aspects of blocks of method 128 or another suitable aspect of other implementations described herein (and vice versa).

Instructions 156 stored on memory resource 150 are, when executed by ASIC processing resource 148, to determine, with the ASIC processing resource, internal state information of the network switch. Instructions 156 can incorporate one or more aspects of blocks of method 128 or another suitable aspect of other implementations described herein (and vice versa).

Instructions 158 stored on memory resource 150 are, when executed by ASIC processing resource 148, to extract, with the ASIC processing resource, a subset of the metadata based on the received pre-processing instructions and the determined internal state information of the network switch. Instructions 158 can incorporate one or more aspects of blocks of method 128 or another suitable aspect of other implementations described herein (and vice versa).

Instructions 160 stored on memory resource 150 are, when executed by ASIC processing resource 148, to compile, with the ASIC processing resource, the extracted subset of metadata into a data structure. Instructions 160 can incorporate one or more aspects of blocks of method 128 or another suitable aspect of other implementations described herein (and vice versa).

Instructions 162 stored on memory resource 150 are, when executed by ASIC processing resource 148, to send, to the CPU processing resource, the data structure compiled by the ASIC processing resource. Instructions 162 can incorporate one or more aspects of blocks of method 128 or another suitable aspect of other implementations described herein (and vice versa).

Each processing resource 146 and 148 of network switch 102 can, for example, be in the form of a central processing unit (CPU), a semiconductor-based microprocessor, a digital signal processor (DSP) such as a digital image processing unit, other hardware devices or processing elements suitable to retrieve and execute instructions stored in memory resource 150, or suitable combinations thereof. Each processing resource 146 and 148 can, for example, include single or multiple cores on a chip, multiple cores across multiple chips, multiple cores across multiple devices, or suitable combinations thereof. Each processing resource 146 and 148 can be functional to fetch, decode, and execute instructions as described herein. As an alternative or in addition to retrieving and executing instructions, each processing resource 146 and 148 can, for example, include at least one integrated circuit (IC), other control logic, other electronic circuits, or suitable combination thereof that include a number of electronic components for performing the functionality of instructions stored on memory resource 150. The term “logic” can, in some implementations, be an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Each processing resource 146 and 148 can, for example, be implemented across multiple processing units and instructions may be implemented by different processing units in different areas of network switch 102.

Memory resource 150 of network controller 112 can, for example, be in the form of a non-transitory machine-readable storage medium, such as a suitable electronic, magnetic, optical, or other physical storage apparatus to contain or store information such as machine-readable instructions 152, 154, 156, 158, 160, and 162. Such instructions can be operative to perform one or more functions described herein, such as those described herein with respect to method 128 or other methods described herein. Memory resource 150 can, for example, be housed within the same housing as one or more processing resources 146 and 148 for network switch 102, such as within a computing tower case for network switch 102 (in implementations where network switch 102 is housed within a computing tower case). In some implementations, memory resource 150 and processing resources 146 and 150 are housed in different housings. As used herein, the term “machine-readable storage medium” can, for example, include Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof. In some implementations, memory resource 150 can correspond to a memory including a main memory, such as a Random Access Memory (RAM), where software may reside during runtime, and a secondary memory. The secondary memory can, for example, include a nonvolatile memory where a copy of machine-readable instructions are stored. It is appreciated that both machine-readable instructions as well as related data can be stored on memory mediums and that multiple mediums can be treated as a single medium for purposes of description.

Memory resource 150 can be in communication with processing resources 146 and 148 via suitable communication links 164 and 166. Each communication link 164 and 166 can be or remote to a machine (e.g., a computing device) associated with one or both processing resources 146 and 148. Examples of communication links can include an electronic bus internal to a machine (e.g., a computing device) where memory resource 150 is one of volatile, non-volatile, fixed, and/or removable storage medium in communication with processing resources 146 and 148 via respective electronic busses.

In some implementations, one or more aspects of network switch 102 (as well as network controller 112 or other devices of network 100) can be in the form of functional modules that can, for example, be operative to execute one or more processes of instructions 152, 154, 156, 158, 160, 162, and/or other functionality described herein relating to other implementations of the disclosure. As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software can include hardware only (i.e., a hardware element with no software elements), software hosted at hardware (e.g., software that is stored at a memory and executed or interpreted at a processor), or hardware and software hosted at hardware. It is further appreciated that the term “module” is additionally intended to refer to one or more modules or a combination of modules. Each module of a network switch 102 can, for example, include one or more machine-readable storage mediums and one or more computer processors.

In view of the above, it is appreciated that the various instructions of network switch 102 described above can correspond to separate and/or combined functional modules. For example, instructions 158 can correspond to metadata extraction module 108 (shown, for example, in FIG. 1) to extract, with ASIC 106, a subset of the metadata based on the received pre-processing instructions and the determined internal state information of network switch 102 and instructions 160 can correspond to data structure compiling module 110 (shown, for example, in FIG. 1) to compile, with ASIC 106, the extracted subset of metadata into a data structure. Likewise, network controller 112 can include pre-processing instructions creation module 113 (shown, for example in FIG. 1) to create It is further appreciated that a given module can be used for multiple functions. In some implementations, a single module can be used to extract metadata (e.g., corresponding to the functionality of instructions 158) as well as to compile the data structure (corresponding to the functionality of instructions 160).

One or more nodes within network 100 (e.g., network controller 112, network switch 102, etc.) can further include a suitable communication module to allow networked communication between network controller 112, network switch 102, and/or other elements of network 100. Such a communication module can, for example, include a network interface controller having an Ethernet port and/or a Fibre Channel port. In some implementations, such a communication module can include wired or wireless communication interface, and can, in some implementations, provide for virtual network ports. In some implementations, such a communication module includes hardware in the form of a hard drive, related firmware, and other software for allowing the hard drive to operatively communicate with other hardware of network controller 112, network switch 102, or other network equipment. The communication module can, for example, include machine-readable instructions for use with communication the communication module, such as firmware for implementing physical or virtual network ports.

FIG. 7 illustrates another example of network switch 102 in accordance with the present disclosure. For illustration, FIG. 7 reproduces various aspects of network switch 102 of FIG. 6, however it is appreciated that network switch 102 of FIG. 7 can include additional or alternative functionality, hardware, or other aspects compared to network switch 102 of FIG. 6 and the method of FIGS. 2-5 and is not intended to be limited by the depiction or description of these network switches. It is further appreciated that network switch 102 of FIG. 6 can incorporate one or more aspects of method 128 of FIGS. 2-4 and vice versa.

Network switch 102 of FIG. 7 illustrates a memory resource 150 that includes two separate storage mediums 168 and 170. In some implementations, first storage medium 168 can correspond to CPU 104 and second storage medium 170 can correspond to ASIC processing resource 148. For example, instructions described above with respect to FIG. 5 can, for example, be split amongst these two storage mediums. For example, as shown in FIG. 7, instructions 152 to send data packet pre-processing instructions can be included on first storage medium 172 and the remaining instructions depicted in FIG. 6 (instructions 154, 156, 158, 160, and 162) can be included on second storage medium.

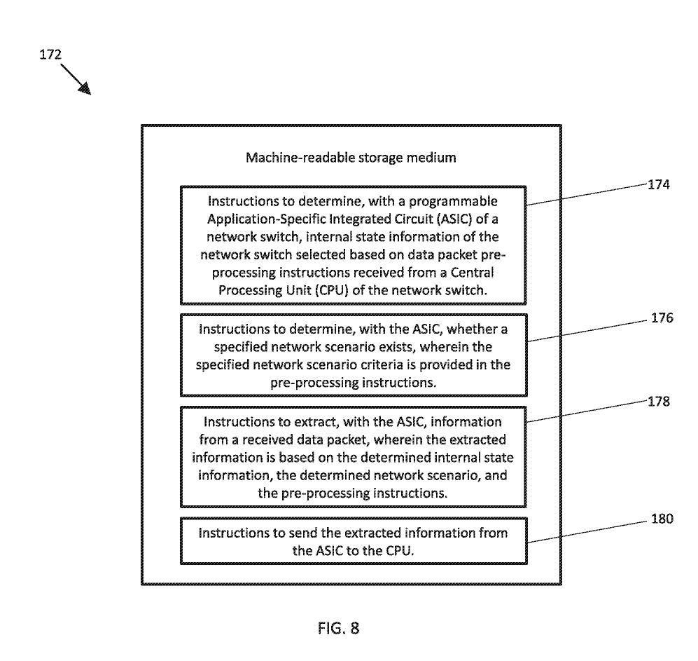

FIG. 8 illustrates a machine-readable storage medium 172 including various instructions that can be executed by a computer processor or other processing resource. In some implementations, medium 12 can be housed within a network controller, such as network controller 112, or on another computing device within network 100 or in or remote wired or wireless data communication with network 100.

For illustration, the description of machine-readable storage medium 172 provided herein makes reference to various aspects of network switch 102 (e.g., processing resources such as CPU processing resource 146 and ASIC processing resource 148) and other implementations of the disclosure (e.g., method 128). Although one or more aspects of network switch 102 (as well as instructions such as instructions 152, 154, 156, 158, 160, and 162) can be applied or otherwise incorporated with medium 172, it is appreciated that in some implementations, medium 172 may be stored or housed separately from such a system. For example, in some implementations, medium 172 can be in the form of Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof.

Medium 172 includes machine-readable instructions 174 stored thereon to cause ASIC processing resource 148 to determine internal state information of the network switch selected based on data packet pre-processing instructions received from a Central Processing Unit (CPU) of the network switch. Instructions 174 can, for example, incorporate one or more aspects of one or more blocks of method 128 or instructions of network switch 102 or another suitable aspect of other implementations described herein (and vice versa).

Medium 172 includes machine-readable instructions 176 stored thereon to cause ASIC processing resource 148 to determine internal state information of the network switch selected based on data packet pre-processing instructions received from a Central Processing Unit (CPU) of the network switch. Instructions 176 can, for example, incorporate one or more aspects of one or more blocks of method 128 or instructions of network switch 102 or another suitable aspect of other implementations described herein (and vice versa).

Medium 172 includes machine-readable instructions 178 stored thereon to cause ASIC processing resource 148 to extract, with the ASIC, information from a received data packet, wherein the extracted information is based on the determined internal state information, the determined network scenario, and the pre-processing instructions. Instructions 178 can, for example, incorporate one or more aspects of one or more blocks of method 128 or instructions of network switch 102 or another suitable aspect of other implementations described herein (and vice versa).

Medium 172 includes machine-readable instructions 180 stored thereon to cause ASIC processing resource 148 to send the extracted information from the ASIC to the CPU. Instructions 180 can, for example, incorporate one or more aspects of one or more blocks of method 128 or instructions of network switch 102 or another suitable aspect of other implementations described herein (and vice versa).

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

As used herein, “logic” is an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Further, as used herein, “a” or “a number of” something can refer to one or more such things. For example, “a number of widgets” can refer to one or more widgets. Also, as used herein, “a plurality of” something can refer to more than one of such things.

What is claimed is:

1. A method comprising:
receiving, with a programmable Application-Specific Integrated Circuit (ASIC) of a network switch, data packet pre-processing instructions;
receiving, with the ASIC, a data packet including payload data and metadata;
extracting, with the ASIC, a subset of the metadata based on the received pre-processing instructions;
compiling, with the ASIC, the extracted subset of metadata into a data structure; and
sending, to the CPU, the data structure compiled by the ASIC.

2. The method of claim 1, further comprising:
determining, with the ASIC, internal state information of the network switch based on the received pre-processing instructions,
wherein extracting the subset of metadata is further based on the determined internal state information of the network switch.

3. The method of claim 1, further comprising:
updating, with the CPU, a routing table stored on the network switch based on the data structure.

4. The method of claim 1, further comprising:
performing, with the CPU, a Deep Packet Inspection (DPI) operation for the data packet based on the data structure.

5. The method of claim 1, wherein the received data packet is not forwarded to the CPU by the ASIC.

6. The method of claim 1, wherein the data structure does not store the payload data of the data packet.

7. The method of claim 1, wherein the pre-processing instructions are received from a Central Processing Unit (CPU) of the network switch.

8. The method of claim 1, wherein the data structure stores a source Media Access Control (MAC) address and a destination MAC address for the data packet.

9. The method of claim 1, wherein the data structure is in the form of a compressed data packet.

10. The method of claim 1, wherein the data packet pre-processing instructions instruct the ASIC to compile a data structure including only data that is used for a specific CPU control task.

11. The method of claim 1, wherein determining internal state information of the network switch includes determining, with the ASIC, state information that is not visible to the CPU.

12. A non-transitory machine readable storage medium having stored thereon machine readable instructions to cause a computer processor to:
determine, with a programmable Application-Specific Integrated Circuit (ASIC) of a network switch, internal state information of the network switch selected based on data packet pre-processing instructions received from a Central Processing Unit (CPU) of the network switch;
determine, with the ASIC, whether a specified network scenario exists, wherein the specified network scenario criteria is provided in the pre-processing instructions;
extract, with the ASIC, information from a received data packet, wherein the extracted information is based on the determined internal state information, the determined network scenario, and the pre-processing instructions; and
send the extracted information from the ASIC to the CPU.

13. The medium of claim 12, wherein the medium is housed within the network switch.

14. A network switch comprising:
a Central Processing Unit (CPU) processing resource
an Application-Specific Integrated Circuit (ASIC) processing resource; and
a memory resource storing machine readable instructions to cause the CPU processing resource and the ASIC processing resources to:
send data packet pre-processing instructions from the CPU processing resource to the ASIC processing resource;
receive, with the ASIC processing resource, a data packet including payload data and metadata;
determine, with the ASIC processing resource, internal state information of the network switch;
extract, with the ASIC processing resource, a subset of the metadata based on the received pre-processing instructions and the determined internal state information of the network switch;
compile, with the ASIC processing resource, the extracted subset of metadata into a data structure; and
send, to the CPU processing resource, the data structure compiled by the ASIC processing resource.

15. The network switch of claim 14, wherein the memory resource includes a first storage medium for the CPU and a second storage medium for the ASIC processing unit.
